(19) United States
(12) Patent Application Publication
(10) Pub. No.: US 2005/0160470 A1
(43) Pub. Date: Jul. 21, 2005

(54) Real-time playback system for uncompressed high-bandwidth video

(76) Inventor: Daryll J. Strauss, Redondo Beach, CA (US)

Correspondence Address: Thomas J. Brindisi, Esq., Suite B, 20 28th Place, Venice, CA, 90291, US

(21) Appl. No.: 10/998,260

(22) Filed: Nov. 26, 2004

Related U.S. Application Data
(60) Provisional application No. 60/524,754, filed on Nov. 25, 2003.

(51) Int. Cl. H04N 7/173; H04N 7/16

(52) U.S. Cl. 725/115; 725/116; 725/145; 725/146; 725/92

(57) ABSTRACT

A playback system preferably suited to the post-production environment for displaying high-bandwidth video in real-time or other specified high-speed rate, preferably with the capacity to obtain from networked file servers video with a variety of formats and network file system protocols. The system preferably includes a dedicated server that houses a CPU, an array of high-capacity hard disk drives, and one or more suitable video graphics display controllers. The system preferably stripes video over the hard disk array, preferably in a stripped and uncompressed form so as to facilitate its high-speed output to a display means. Remote user access to one or more functions of the system is preferably provided by a network or web interface, and playback preferably may be controlled via an input device such as a jog/shuttle controller.

### RELATED APPLICATIONS

The present application claims the benefit of Provisional Application Ser. No. 60/524,754 filed on Nov. 25, 2003 and entitled “Realtime Playback for Film and Video,” the disclosure of which is incorporated by reference as if set forth fully herein except to the extent of any inconsistency with the express disclosure hereof.

### FIELD OF THE INVENTION

The present invention relates to video production and display, and more particularly, to a system that permits the display of high-bandwidth video in real-time or other specified high-speed rate, preferably without compression.

### BACKGROUND OF THE INVENTION

In the post-production industry, digital video material is obtained (directly such as from a digital video camera recording, or indirectly such as by scanning it from film) and then stored and manipulated on computers. The numerous frames of the video material are stored as individual files, which are then displayed at a given frame rate (e.g., 24 or 30 fps) to play the material back (“playback”). Each frame of uncompressed video material, for example from film or HDTV, may comprise many megabytes of data.

Since displaying video without compression would require an extremely high data throughput for the network (if any), storage system and controller, memory system, and graphics system, various prior art post-production playback systems have relied upon video compression to reduce the needed bandwidth. Compression loses some of the material's original color and detail, however, which may be undesirable to a user in the post-production process who may need to consider the material's color and detail highly accurately.

Various prior art post-production playback systems have also utilized the very high bandwidth of RAM to attain real-time playback by loading frames of video into RAM prior to displaying them. This technique is significantly limited, however, because the number of frames that can be loaded is limited by the amount of memory in the system.

Another drawback to certain prior art post-production playback systems is that they are implemented as software executed on a user's general purpose computer, which generally requires the user to stop running other programs on the computer during the loading and playback of video.

### SUMMARY OF THE INVENTION

An exemplary embodiment of a playback system according to the present invention is preferably suited to the post-production environment, for displaying high-bandwidth video in real-time or other specified high-speed rate, and preferably has the capacity to obtain from connected file servers video with a variety of formats and network file system protocols. The system preferably includes a dedicated server that houses a CPU, an array of high-capacity hard disk drives, a system disk drive, and one or more suitable video graphics display controllers. The system preferably stripes video over the hard disk array, preferably in a stripped and uncompressed form so as to facilitate its high-speed output to a display means. Remote user access to one or more functions of the system is preferably provided by a network or web interface, and playback preferably may be controlled via an input device such as a jog/shuttle controller.

### BRIEF DESCRIPTION OF THE DRAWINGS

FIG. 1 is a diagram of an example of a network in which the playback system of the present invention may be employed.

FIG. 2 is a perspective view of a preferred embodiment of a playback system according to the present invention.

FIG. 3 is a perspective view of a preferred embodiment of a jog/shuttle controller that may be used to operate the playback system depicted in FIG. 2.

FIG. 4 is screenshot showing a sample status page utilized in the network interface of a preferred embodiment of the present invention, which a user may access at a workstation on the network.

FIG. 5 is screenshot showing a sample interactive form utilized in the network interface of a preferred embodiment of the present invention, which a user may access at a workstation on the network in order to load a set of frames on the playback system.

FIG. 6 is partial screenshot showing a sample pop-up menu utilized in the playback application of a preferred embodiment of the present invention, which a user may access at the playback server.

FIG. 7 is a diagram of a playback system optionally configured for simultaneous video playback on multiple monitors.

### DETAILED DESCRIPTION OF A PREFERRED EMBODIMENT

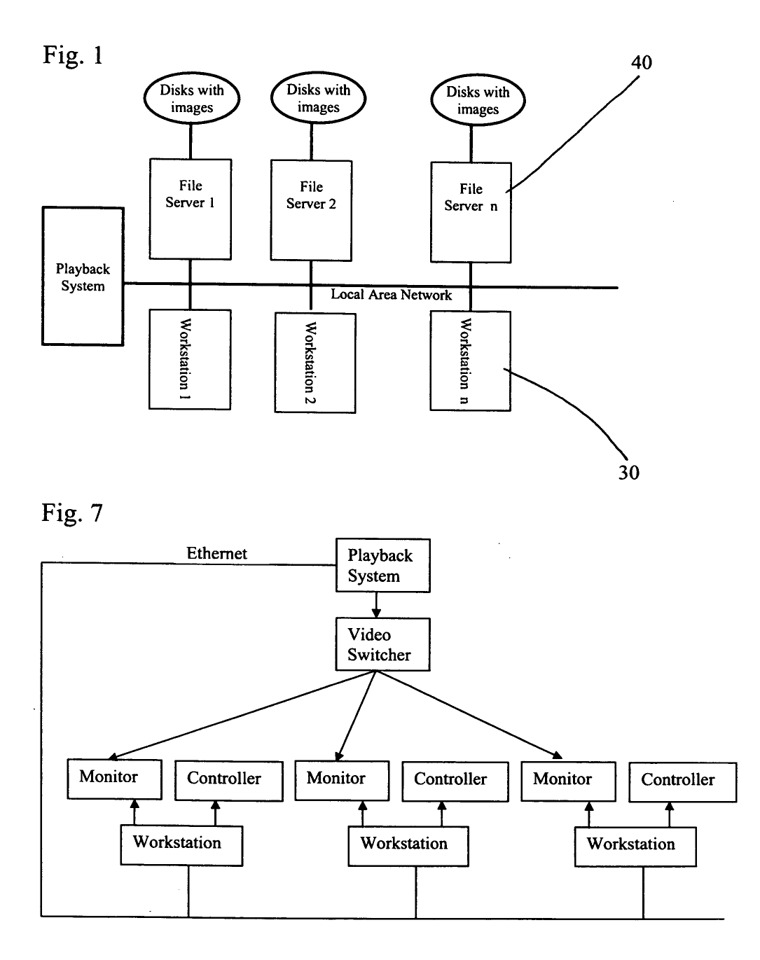

FIG. 1 shows a network environment in which the playback system of the present invention may be employed. Workstations 30 are used to create, view, and/or manipulate sets of frames stored on file servers 40. The workstations 30 and file servers 40 may be running a variety of different operating systems and using different network file system protocols.

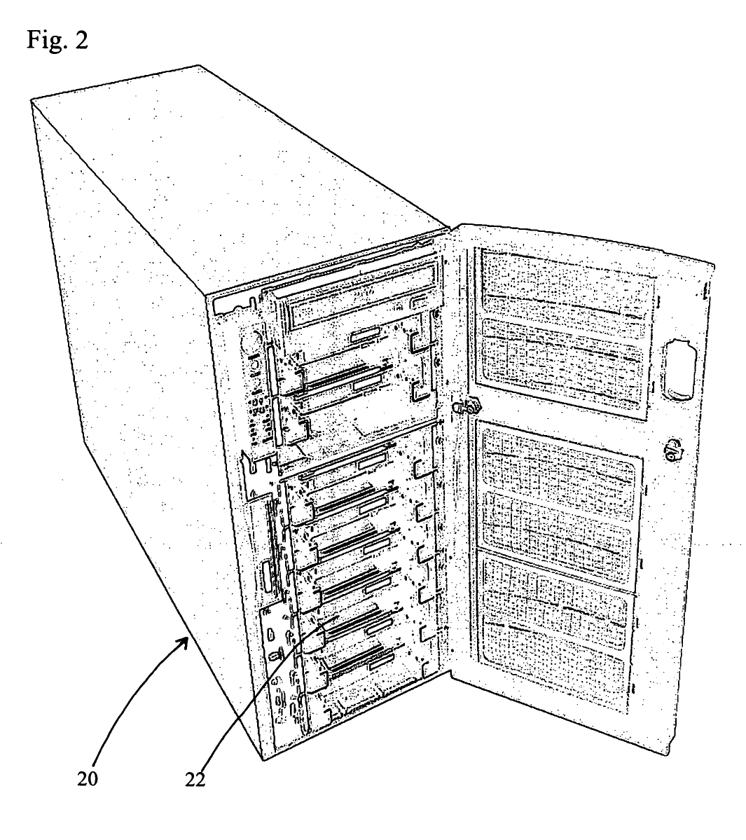

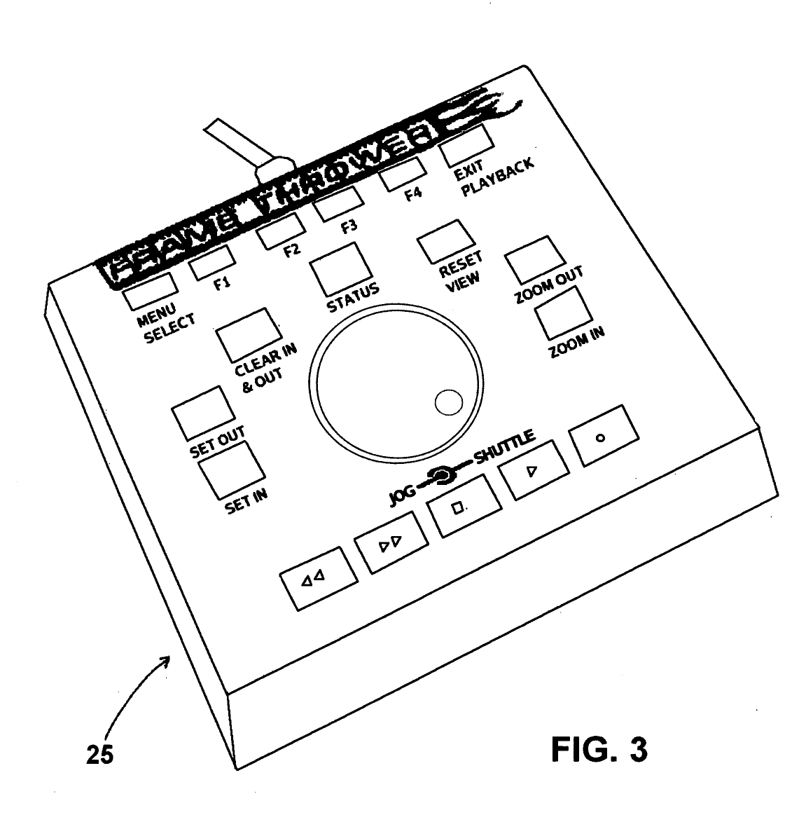

Referring now to FIGS. 2 and 3, a preferred embodiment of a playback system according to the present invention primarily comprises a dedicated playback server 20, a jog/shuttle controller 25 (which in another preferred embodiment may have separate dials for R, G, and B, and additional buttons for presets and the like to facilitate editing), and a high-resolution monitor (not shown). The playback server 20 preferably includes a CPU (or more than one, for example, two Pentium 4 Xeon® processors), an array of hard disk drives 22 (eight 300 Gb storage disk drives in the depicted preferred embodiment; optionally an embodiment may be configured in which there is room for expansion to accommodate more disk drives), a system disk drive, and one or more suitable video graphics display controllers (e.g., an nVidia FX-1100®). A playback application is loaded on the playback server 20, and a graphical user web or network interface application (hereafter “network interface”) is loaded on the playback server 20 as well as desired workstations 30 on the network.

The first use of the system is typically to configure parameters appropriate for the network in which it is placed. The system administrator may manipulate the playback system using the network interface, which will first verify the user's authenticity and authorization to perform administrative functions. The administration is then presented with a menu that allows him or her to perform functions such as define video parameters, list the servers the system can access and what network protocol to use when accessing them, determine which lookup table (“LUT”) should be the default, and determine how and by which system users are to be authenticated.

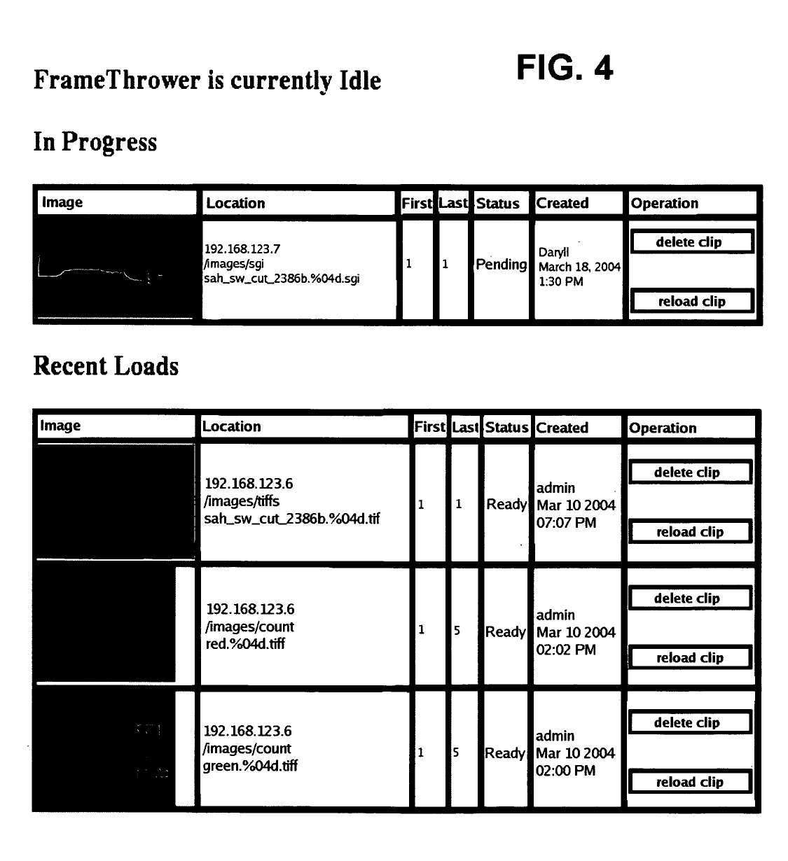

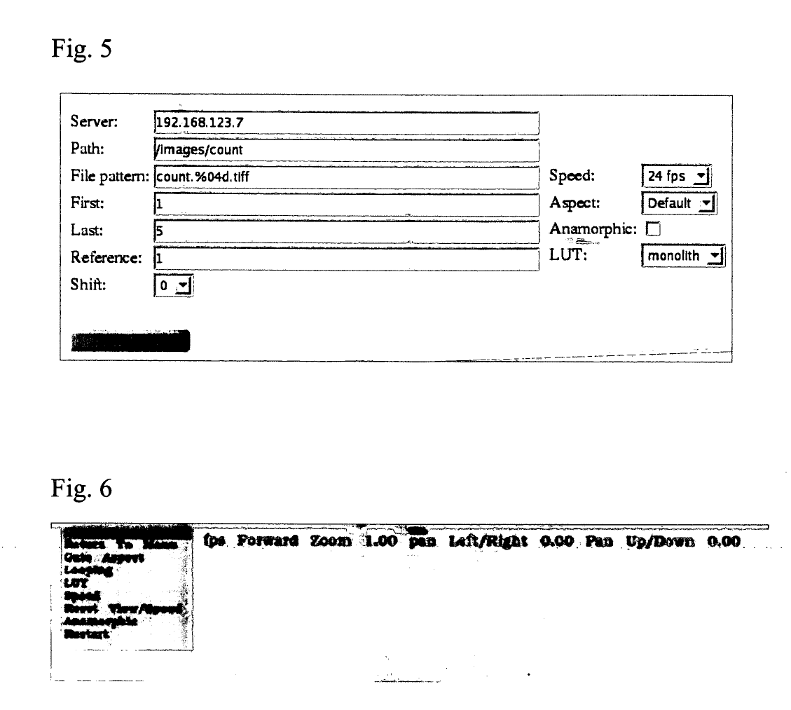

The system is then ready for normal operation. Typically, the system is used to load a set of frames, then to play them back, and finally to remove them from the system. Each of these steps will be discussed in order. If a user desires to load a set of frames, the user first logs onto the system using the network interface (preferably running on the user's workstation 30), which authenticates the user against any mechanisms that have been configured by the system administrator. If desired, the user can check a status page (shown in FIG. 4) to determine the status of the playback system (such as whether it is available to load a new set of frames). In any case, the user may queue the system to load a set of frames through a form provided by the network interface. The form permits the user to select a single representative frame from a desired set of frames and enter a directory on the system in which the set of frames should be stored. When the user submits this data through the form, another page (shown in FIG. 5) is presented showing details of the set of frames that contains the representative frame. The user can then change these parameters if necessary to suit their playback, and can specify whether notification is desired when the frames have finished loading. While waiting for the selected set(s) of frames to be loaded, the user can again check the status page to see what the playback system is currently doing, and how far the particular set(s) of frames has progressed. The system may also be configured to notify the user that the selected set of frames is ready for playback once loaded.

The user can now operate the playback system using the jog/shuttle controller 25 or other suitable input device, either directly connected to the playback system, or remotely such as through the workstation's network connection. The playback application then causes directories and sets of frames to be displayed on the playback system's monitor (and optionally, also on the workstation's monitor as described with regard to FIG. 7 below). The user uses the jog/shuttle or other input device to traverse the directories and select the set of frames they want to play back, and then views the frames as they are played back. The user may change the speed of the playback, zoom in or out, pan the image around to view different regions, and select a different color look up table for playback. The playback continues to run until the user requests it to stop. Playback can be run forward or backward and several choices are available for the user to indicate which frames in the set should be displayed and what to do when the system reaches the end. Such functions are preferably accessed via buttons on the jog/shuttle controller 25 or other input device, with a pop-up menu (shown in FIG. 6) being displayed when necessary to access more functions.

When the user is done playing the set of frames, the system can be accessed through the network interface, and the user can then select the set of frames and request that it be reloaded or deleted. If it is reloaded, the frames of the set of frames will be read by the server. If the user decides to delete the set of frames, the space is made available to be used later. The network interface may also be used to perform searches on several different parameters stored in the playback server's SQL database (which is preferably stored on the playback server's system disk drive along with other administrative data so that the storage disk array can be used exclusively for video storage and playback) as described further below, resulting in a list of the sets of frames that meet the search parameters. The user may then choose to reload or delete some of the selected sets of frames by marking them and then pressing a button on the network interface.

The operation of the network interface on the playback system will now be described in more detail. The playback process runs with a real-time priority and the kernel will schedule this process before any other process on the system. The network interface runs at a lower priority than the playback system. By lowering the priority, the network interface continues to operate during video playback, but does not impact playback performance. When the user first connects to the network interface they are authenticated to insure they are a valid user. The system may be configured to allow restriction of which functions a user can perform. The user name and password may be verified against a local list and/or distributed authentication systems. Once the user is authenticated, a number of operations are preferably available. The user may browse material stored on the system, and may request frames to be loaded onto the playback system from network storage locations in any supported format. The user may also check the status of the playback system, including information such as what operations the playback system is currently performing (which information, whenever it changes, is stored by the playback application in the database), lists of the sets of frames that have been loaded recently (which lists are created by database queries based on the date, the current frame, or the error fields in the database), the available space on the system, any error messages, and other pertinent information. The user may also add or remove color look up tables stored in the playback system's database, and may also set a number of administrative options including which servers use which protocols for their disks, which users are allowed to access the device and how their logins are authenticated, how the video output is configured in the system, how the system is connected to the local area network, and licensing. Again, all this information is stored in the fields of a table in the database. The network interface may preferably be configured to accept commands from other programs (e.g., an asset management application to identify where files reside on the network).

Next, the sequence of operations performed to load a set of frames onto the playback server will be described. First, the user interacts with the network interface to browse and select a single frame from a set of frames. This filename and a location for storing the frame are sent to the playback system via a form provided by the network interface. The system then examines the path provided and compares it against a list of known file servers. This allows the system to determine which network protocol is used to access the file. Once the server, file system, and protocol are determined, a list of mounted file systems is consulted. If the file system is not yet mounted, it is mounted before proceeding. The system then accesses the file on that server. The system uses the file name provided to find additional frames included in the set, for which it then allocates adequate space on the disks. The filename will include a sequence number just before the possible extension. The additional frames will have different sequence numbers in the same series. By finding all the frames that match that pattern, the system can find the lowest and highest sequential frame number that contains the reference frame. Next the system will read the specified frame and determine its format, representation of pixels, and range of colors. The type of file can be determined by the file name, but if that doesn't find the type, then a portion of the file can be read to identify the file type. These values are later used during playback and as shown in FIG. 5, are presented back to the user through another form in the network interface for approval and to allow modifications. The user can specify additional information such as the color look up table desired, whether the frames should be refreshed when they change on the server, and whether or not the user wants to be notified when the frames have finished loading. Finally, all this information to be used in loading the video is stored in an SQL database for use during loading and playback. The database is preferably stored on the system disk to avoid reducing video storage and playback performance.

The process of loading the frames is handled by the playback application, described next. The playback application provides two distinct functions: (1) when not playing back video, loading video and organizing it on the playback server's disk array 22 for optimal performance, and (2) playing back video. The playback of video runs at a real-time priority so that it cannot be interrupted by other operations.

As noted, the playback application loads video onto the disk array of the playback server when it is not busy performing a playback. The playback application recognizes that it is idle when it is not playing back video and the system has not received user input for a specified period of time. When idle, the application consults the database to find a set of frames that need to be loaded. (The description of the frames was inserted into the database as described above). If there are multiple sets of frames that need to be loaded, the application cycles between them in a round robin manner loading one frame from each set before moving on to the next. The frames may be stored on the file servers 40 in a variety of different formats, which the playback application is preferably configured to recognize and read. To expedite processing by the graphics controller, before writing the frames to the disk array, the playback application preferably converts them to be stored as only their color data (rather than in their native image format), with additional information such as their width and height being instead stored in the database. Further, since different graphics controllers may run more efficiently if the video data is presented in one format or another, the playback application also preferably organizes the data in the most efficient or native format for the selected graphics controller, such as by changing the number of bits per color component, changing the order of the color components (e.g., RGB to BGR), padding the data to various boundaries, and/or other format changes. Once the frames are aligned, padded, and otherwise formatted properly, they can be read and written between the disk and the playback application using direct memory transfers. The playback system preferably uses asynchronous direct I/O to “stripe” the data across multiple disks, i.e., split the data small chunks that are distributed evenly across all the disk drives in the system. The first chunk goes to the first drive, the second chunk goes to the second drive, etc. until all drives have been used. This process of striping frames across the drives is repeated until the entire selected set of frames is loaded on the drives. The offset that marks the beginning of a set of frame is stored in the database on the system disk and associated with that set of frames. U.S. Pat. No. 6,118,931 to Bopardikar entitled “Video Data Storage” is incorporated herein by reference for its disclosure of striping data across an array of multiple hard disk drives.

Once the last frame in the set is loaded, the playback application checks the database to determine if the user requested to be notified when the set of frames has finished loading, in which case the application notifies (e.g., by email or instant message) the user that the set of frames is ready for viewing. If no more sets of frames need to be loaded, the application then checks for sets of frames that were marked to be refreshed. The time and date a request was made is checked against the times and dates on the files on the file server, and if the frames have changed on the server, they are queued to be reloaded. If no frames need to be loaded or refreshed and the application continues to remain idle, the application will then work to optimize the disk space on the server. Adding and removing frames from the disk inevitably creates interstitial gaps that are not useful to store further images and thus reduce disk storage and operating efficiency. To alleviate this problem the playback application when idle moves the frames so that there is no space between them. The set of frames are sorted by their disk offset and then each in term is moved to the lowest numbered unused sector of the disk. This operation may require moving one or more sets of frames to a temporary location to make space. Assuming the system disk is not of adequate size to handle the data swapping potentially involved in this operation, the storage disk array may be used by employing the following algorithm:
(1) The sets of frames are examined to find the first gap;
(2) The size of the set of frames immediately following the gap is determined;
(3) If the gap is large enough to store the set of frames, the set of frames is moved into the gap and the process is repeated;
(4) If the gap is not large enough to store the set of frames, then another gap is found further on the disk, the frames are moved there, and the process is repeated;
(5) If there is no gap large enough for the set to be moved, other sets of frames are examined to determine the largest set that will fit in the initial gap, and that set is moved into the gap. Any remainder in the gap is ignored and the process continues.

Next, the process for playing back video on a display using direct memory access is described. The user may select a set of frames to display using the jog/shuttle controller and its buttons. Once the set of frames is selected, the application consults the database to decide which color look up table is to be used, and the appropriate table is then loaded into the graphics controller. If the user has requested a limited set of color channels to be displayed, the graphics controller is configured to display the video with only those colors. The application then begins a loop of loading and displaying frames. Rather than having the playback system's CPU process color data, the disk controller(s) (for example, two Adaptec AIC7902® Ultra 320 SCSI controllers each controlling four Seagate ST3300007LW disk drives operating at 50 MB/s will provide approximately 400 MB/s thoughtput) reads each frame preferably into a system memory reserved for use by the graphics controller as part of an AGP graphics controller, and the graphics controller reads the memory to display a corresponding image on the screen. In the preferred embodiment described here, an OpenGL pixel buffer object extension may be used to load the image data into a texture map on the graphics controller. This extension provides an address space to store the frame in memory such that the graphics controller can access it. This address space is used as the destination for the disk read operations. The application keeps track of all the sets of frames on the disk by storing their size and their offset in the database. As noted, the data is stored in sequential sectors and split across all the disks to increase the total bandwidth. Further, the application will then find the smallest available free space that will fit the set of frames, so that the disks will always be performing sequential reads without having to seek the heads of the disk, and all disks run in parallel to maximize the bandwidth. As with writing, read of the video is done with asynchronous direct I/O. The application generates a thread that sets up all the read operations so that they read a frame directly into the memory provided by the pixel buffer object extension. The read request is then sent to the disks via the asynchronous direct I/O interface and the thread then waits for the operation to complete. Meanwhile, the CPU can perform other operations as the disk controller is sending the data directly to memory. To load each frame, the playback application allocates a chunk of AGP-controlled system memory that is aligned and sized appropriately to store the image data in a format that is compatible with both the disk controller and the graphics controller. The playback application then instructs the disk to load a frame into that space and then instructs the graphics controller to insert it into a texture map. Finally, a quadrilateral is drawn that is the size of the screen and texture mapped with newly updated texture. This is a multi-threaded process. The disk controller continually reads images into a fixed set of buffers until they are full. The graphics controller is continually instructed to display the image in those buffers until they are empty. Each frame is displayed for an exact period of time, insuring that the images are displayed at the correct frame rate. The image layout and the multi-threaded playback together optimize playback performance and insure that video is always played back at the correct frame rate.

The video displayed on the screen may also optionally be manipulated with the graphics processing unit on the graphics controller. For example, programmable shaders can be applied to the quadrilateral being drawn to perform real-time color correction, three dimensional color look up tables, and other image processing. These operations on the pixels may be applied for example with OpenGL fragment shaders written to perform the required calculations, in which just prior to drawing the quadrilateral, the parameters of the shader are set and the shader activated, allowing the graphics hardware to perform a wide variety of processing operations on the pixels of an image without burdening the playback server's CPU.

During playback, the user may control the video by manipulating the jog/shuttle controller, and/or another alternate means such as a remote control wirelessly connected to the network. For example, the user may be provided with the option to change the playback rate and colors displayed, compress the image vertically, change the region of the image displayed such as by “gating” it, zoom and pan (preferably implemented by modifying the OpenGL viewing transform) the image horizontally or vertically to view different regions of the image, change the sequence of frames to play forward or backward, and/or limit which frames are displayed.

Optionally, multiple sets of frames may be displayed in a series, and the user can decide which frame to play next from the current set or the next one. Two sets may be strung together in this way to playback as a single larger set, permitting the user to review how multiple sets of frames fit together. These lists of sets of frames can be created through interaction with the network interface, and then played back with no further processing required.

The system can also optionally be configured to permit the simultaneous display of multiple sequences of frames, with a choice of one or modes such as side-by-side, alternating window, or split-screen showing a portion of each. To accommodate this simultaneous multiple display, however, video may have to be stored on the disk in a reduced format to permit real-time display. (Likewise, even with only a single display, for purposes of economy a playback system could also be configured that has a bandwidth capability less than that necessary to handle full resolution and color depth film or HDTV, in which case video would have to be stored in a compressed and/or downconverted resolution and/or color format). For example, the frames may preferably be scaled down to a size at which together they consume the same bandwidth as a single set of full-size original frames. In such a configuration, the user could select a second set of frames to be displayed, in response to which the playback server would calculate what size the two sets of frames must be reduced to (if at all) while still permitting real-time playback. (In this regard, U.S. Patent Application Publication 2004/0199359 to Laird entitled “Predicting Performance of a Set of Video Processing Devices” is incorporated herein by reference). A new portion of the disk could then be allocated that is adequate for all the frames, and the frames stored in a one-by-one interleaved fashion. During playback, the new set of frames would be read sequentially to provide two images.

As shown in FIG. 7, the system can also optionally be configured for playback of the same video on multiple monitors, such as by attaching a splitter to the video output of the playback server. This allows the user to see the playback server's video output on their own monitor instead of having to use the monitor on the playback server. A jog/shuttle controller can be attached to other workstations and via a remote protocol it can drive the playback system. This allows the video signals to be sent as a second input to workstations and be remotely controlled. The remote workstation starts an application that connects to the playback application over the network. Each button and knob on the jog/shuttle controller sends a network packet to the playback application, which interprets and processes them as if they were generated locally.

It is noted that the system described above may also be configured for the playback of sound that is synchronized with the video playback. In this case, during the loading stage, the user provides the system with the location of a sound file, which preferably can be read by the system in a variety of well known formats. The system will examine its database to determine the location of the sound file in the same manner as locating the images, and store this location in the database along with the set of images. After the first frame has finished loading, the system then consults the database to determine the location of the sound file and reads the file over the network. The sound file is then processed into a standardized format that is ready for playback on a sound card preferably also included in the playback server. The sound file is then written to the system disk for use during playback. Prior to starting the playback of a set of frames, the sound file is memory mapped so that sound files much larger than the available memory in the system can be supported. A new thread is created to process sound playback, and when the playback process has displayed the first frame of a selected set, the sound thread is signaled to begin audio playback. Audio continues to run until the user stops or otherwise modifies the playback. At this point the audio is stopped and the audio parameters are changed as necessary. When the user begins the playback again, the audio thread is signaled to begin playback.

A preferred embodiment of a real-time high-bandwidth video playback system has thus been disclosed. It will be apparent, however, that various changes may be made in the form, construction, and arrangement of the system without departing from the spirit and scope of the invention, the form hereinbefore described being merely a preferred or exemplary embodiment thereof. Therefore, the invention is not to be restricted or limited except in accordance with the following claims.

1. A system for displaying high-bandwidth video at a high-speed rate, comprising a dedicated playback server including a CPU, an array of high-capacity hard disk drives, and a video graphics controller, wherein said system is configured to store video on said disk drives in a striped and stripped format, and wherein said system is configured to playback video by outputting it from said disk drives to said graphics controller through direct memory transfers.

2. The system of claim 1, further comprising a display means.

3. The system of claim 1, further comprising a jog/shuttle controller with buttons configured for convenient manual access.

4. The system of claim 1, wherein said high-speed rate is real-time.

5. The system of claim 1, further comprising a playback application loaded on said CPU of said playback server and configured to playback video and to store and organize video data on said disk drives.

6. The system of claim 5, wherein said system is configured to operate in a network environment.

7. The system of claim 6, further comprising a network interface application that provides remote user access to one or more functions of the system.

8. The system of claim 6, wherein said system has the capacity to obtain from networked file servers video with a variety of formats and network file system protocols.

9. The system of claim 1, wherein said system includes at least one SCSI disk controller and is configured to display video at a throughput of approximately 100 Mb/s or greater.

10. The system of claim 1, wherein said system includes at least two SCSI disk controllers and eight disk drives and is configured to display video at a throughput of approximately 400 Mb/s or greater.

11. The system of claim 1, wherein said system is configured to store and display uncompressed video.

12. The system of claim 10, wherein said system is configured to store and display uncompressed video.

13. The system of claim 1, further configured to permit simultaneous video playback on multiple monitors.

14. The system of claim 1, further configured to permit simultaneous display of multiple sequences of frames.

15. The system of claim 1, further comprising an alternate control means remotely connected to said playback server.

16. The system of claim 1, wherein said system is configured to both store and read video data on said disk drives using asynchronous direct I/O.

17. The system of claim 1, further configured to permit a user to select multiple sets of frames of video to be displayed in a set sequence selected by the user.

18. The system of claim 1, further configured to permit a user to manipulate the display of video through the selection and application of color lookup tables.

19. The system of claim 1, further configured to permit the storage of information pertaining to video displayed by said system so as to permit subsequent reference to said information by a user.

20. The system of claim 1, further configured to permit the storage and readout of audio information synchronized with video playback.

21. The system of claim 1, wherein said graphics controller includes a using a processing unit configured to perform uncompressed real-time image processing on video data.
